(19) United States
(12) Patent Application Publication
(10) Pub. No.: US 2024/0137422 A1
(43) Pub. Date: Apr. 25, 2024

(54) EDGE EXPOSURE CONTEXT TRANSFER

(71) Applicants: Wenliang Xu, Shanghai (CN); Telefonaktiebolaget LM Ericsson (publ), Stockholm (SE)

(72) Inventor: Wenliang XU, Shanghai (CN)

(73) Assignee: Telefonaktiebolaget LM Ericsson (publ), Stockholm (SE)

(21) Appl. No.: 18/547,691

(22) PCT Filed: Feb. 4, 2022
(86) PCT No.: PCT/CN2022/075320

§ 371 Date: Aug. 23, 2023

(30) Foreign Application Priority Data
Feb. 24, 2021 (WO) PCT/CN2021/077548

(51) Int. Cl. H04L 67/148

(52) U.S. Cl. CPC H04L 67/148

(57) ABSTRACT

A first method performed by a first network function implementing Edge Enabler Server (EES). The first method comprises receiving a first request message comprising information regarding exposure context information, from a second network function implementing Edge Application Server (EAS). The first method further comprises transmitting a second request message for retrieving the exposure context information to a third network function implementing EES, in response to the information regarding exposure context information. The first method further comprises to receive a first response message including the retrieved exposure context information from the third network function. The first method further comprises to transmit a second response message including information regarding the retrieved exposure context information to the second network function. The disclosed techniques offer an option to transfer EDGE-3 exposure context between the EESs so that the existing subscriptions can be re-used.

### TECHNICAL FIELD

The embodiments herein relate generally to the field of edge computing, and more particularly, the embodiments herein relate to edge exposure context transfer.

### BACKGROUND

The third Generation Partnership Project (3GPP) Technical Specification (TS) 23.558 Release 17 (v1.3.0) specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications.

When a User Equipment (UE) moves to a new location, different Edge Application Servers (EASs) can be more suitable for serving the UE. Such transitions can result from a non-mobility event also, requiring support from the edge enabler layer to maintain the continuity of the service. Support for service continuity provides several features for minimizing the application layer service interruption by replacing the serving EAS (called source EAS, i.e., S-EAS) connected to the Application Client (AC) in the UE, with a target EAS (i.e., T-EAS).

### SUMMARY

In view of above typical case, the embodiments herein propose methods, network functions, computer readable mediums and computer program products for edge exposure context transfer.

In some embodiments, there proposes a first method performed by a first network function implementing Edge Enabler Server (EES). The first method may comprise the step of receiving a first request message comprising information regarding exposure context information, from a second network function implementing EAS. The first method may further comprise the step of transmitting a second request message for retrieving the exposure context information to a third network function implementing EES, in response to the information regarding exposure context information. The first method may further comprise receive a first response message including the retrieved exposure context information from the third network function. The first method may further comprise transmit a second response message including information regarding the retrieved exposure context information to the second network function.

In an embodiment, the exposure context information may be EDGE-3 exposure context information.

In an embodiment, the first request message may be Application Context Relocation (ACR) complete request message. Furthermore, the information regarding exposure context information may include a list of Edge-3 exposure context or subscription identifiers (IDs), and the endpoint information of the third network function.

In an embodiment, the second request message may be Retrieve Edge-3 exposure context request message, and may include the list of Edge-3 exposure context or subscription IDs.

In an embodiment, the first response message may be Retrieve Edge-3 exposure context response message. Furthermore, the retrieved exposure context information may include the context information of Edge-3 exposure subscriptions.

In an embodiment, the first method may further comprise the steps of storing the retrieved exposure context information. In an embodiment, the first method may further comprise the steps of in response to the retrieved exposure context information, updating the list of Edge-3 exposure context or subscription IDs.

In an embodiment, the second response message may be ACR complete response message, and may include the result of Edge-3 exposure context retrieval, and/or a list of updated Edge-3 exposure context or subscription IDs.

In an embodiment, the second network function may be associated with the first network function, for example the second network function may be registered on the first network function.

In an embodiment, the third network function may be the serving network function for UE. Furthermore, the first network function and the second network function will be the serving network functions for the UE.

In an embodiment, the third network function may be located in a first Edge Date Network (EDN), while the first network function and the second network function may be located in a second different EDN. In another embodiment, the first network function, the second network function, and the third network function may be located in the same EDN.

In an embodiment, the first request message and the second response message may be sent over the Edge-3 reference point. Furthermore, the second request message and the first response message may be sent over the Edge-9 reference point.

In an embodiment, the second request message and the first response message may be sent and received via the Eees_ContextRetrieval Application Programming Interface (API) provided by the first network function and the third network function.

In an embodiment, the context information of Edge-3 exposure subscriptions may be used for providing access to network capability information, such as location information, Quality of Service (QoS) related information, and User Plane Path Management related information.

In an embodiment, the context information of Edge-3 exposure subscriptions may include the 3GPP Core Network context information created during Edge-3 interaction.

In an embodiment, the first method may further comprise the step of transmitting an ACR complete message to a component (such as Edge Enabler Client (EEC)) in the UE.

In some embodiments, there proposes a second method performed by a second network function implementing EAS. The second method may comprises the step of transmitting a request message comprising information regarding exposure context information to a first network function implementing EES. The second method may further comprise the step of receiving a response message from the first network function. The response message may include information regarding the retrieved exposure context information, which is retrieved from a third network function implementing EES.

In an embodiment, the exposure context information may be EDGE-3 exposure context information.

In an embodiment, the request message may be ACR complete request message. Furthermore, the information regarding exposure context information may include a list of Edge-3 exposure context or subscription identifiers (IDs), and the endpoint information of the third network function.

In an embodiment, the response message may be ACR complete response message, and may include the result of Edge-3 exposure context retrieval, and/or a list of updated Edge-3 exposure context or subscription IDs.

In an embodiment, the second network function may be associated with the first network function, for example the second network function may be registered on the first network function.

In an embodiment, the third network function may be the serving network function for a UE. In an embodiment, the first network function and the second network function will be the serving network functions for the UE.

In an embodiment, the third network function may be located in a first EDN, while the first network function and the second network function may be located in a second different EDN. In another embodiment, the first network function, the second network function, and the third network function may be located in the same EDN.

In an embodiment, the request message and the response message may be sent over the Edge-3 reference point. In an embodiment, the exposure context information may be retrieved over the Edge-9 reference point.

In an embodiment, the exposure context information may be retrieved via the Eees_ContextRetrieval API provided by the first network function and the third network function.

In an embodiment, the context information of Edge-3 exposure subscriptions may be used for providing access to network capability information, such as location information, QoS related information, and User Plane Path Management related information.

In an embodiment, the context information of Edge-3 exposure subscriptions may include the 3GPP Core Network context information created during Edge-3 interaction.

In an embodiment, the second method may further comprise the step of reusing the retrieved exposure context information. In another embodiment, the second method may further comprise the step of re-subscribing the exposure subscriptions on the first network function.

In some embodiment, there proposes a third method performed by a third network function implementing EES. The third method may comprise the step of receiving a request message for retrieving the exposure context information from a first network function implementing EES. The third method may further comprise the step of transmitting a response message including the retrieved exposure context information to the first network function.

In an embodiment, the exposure context information may be EDGE-3 exposure context information.

In an embodiment, the request message may be Retrieve Edge-3 exposure context request message, and may include a list of Edge-3 exposure context or subscription IDs.

In an embodiment, the response message may be Retrieve Edge-3 exposure context response message. In an embodiment, the retrieved exposure context information may include the context information of Edge-3 exposure subscriptions.

In an embodiment, the third network function may be the serving network function for a UE. In an embodiment, the first network function will be the serving network function for the UE.

In an embodiment, the third network function may be located in a first EDN, while the first network function is located in a second different EDN. In another embodiment, the first network function and the third network function may be located in the same EDN.

In an embodiment, the request message and the response message may be sent over the Edge-9 reference point.

In an embodiment, the request message and the response message may be sent and received via the Eees_ContextRetrieval API provided by the first network function and the third network function.

In an embodiment, the context information of Edge-3 exposure subscriptions may be used for providing access to network capability information, such as location information, QoS related information, and User Plane Path Management related information.

In an embodiment, the context information of Edge-3 exposure subscriptions may include the 3GPP Core Network context information created during Edge-3 interaction.

In an embodiment, the third method may further comprise the step of receiving an ACR complete request message from a fourth network function implementing EAS. In an embodiment, the third method may further comprise the step of transmitting an ACR complete response message to the fourth network function.

In an embodiment, the third method may further comprise the step of transmitting an ACR complete message to a component (such as EEC) in the UE.

In some embodiment, there proposes a first network function implementing EES. The first network function may comprise at least one processor and a non-transitory computer readable medium coupled to the at least one processor. The non-transitory computer readable medium may contain instructions executable by the at least one processor, whereby the at least one processor is configured to perform the above first method.

In some embodiment, there proposes a second network function implementing EAS. The second network function may comprise at least one processor and a non-transitory computer readable medium coupled to the at least one processor. The non-transitory computer readable medium may contain instructions executable by the at least one processor, whereby the at least one processor is configured to perform the above second method.

In some embodiment, there proposes a third network function implementing EES. The third network function may comprise at least one processor and a non-transitory computer readable medium coupled to the at least one processor. The non-transitory computer readable medium may contain instructions executable by the at least one processor, whereby the at least one processor is configured to perform the above third method.

In some embodiments, there proposes a computer readable medium comprising computer readable code, which when run on an apparatus, causes the apparatus to perform any of the above methods.

In some embodiments, there proposes a computer program product comprising computer readable code, which when run on an apparatus, causes the apparatus to perform any of the above methods.

The embodiments herein offer an option to transfer Edge-3 exposure context between the EESs so that the existing subscriptions can be re-used.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for enabling Edge applications;

FIG. 2 is a schematic block diagram showing an example inter-EDN EDGE-9;

FIG. 3 is a schematic block diagram showing an example intra-EDN EDGE-9;

FIG. 4 is a schematic signaling chart showing the messages in the Application Context Relocation complete procedure, according to the embodiments herein;

FIG. 5 is a schematic block diagram showing an example capability exposure for enabling edge applications, according to the embodiments herein;

FIG. 6 is a schematic signaling chart showing the messages in the ACR procedure initiated by EEC and ACs, according to the embodiments herein;

FIG. 7 is a schematic signaling chart showing the messages in the EEC executed application context relocation procedure, according to the embodiments herein;

FIG. 8 is a schematic signaling chart showing the messages in the Source EAS decided application context relocation procedure, according to the embodiments herein;

FIG. 9 is a schematic signaling chart showing the messages in the S-EES executed application context relocation procedure, according to the embodiments herein;

FIG. 10 is a schematic signaling chart showing the messages in the EEC executed application context relocation via T-EES, according to the embodiments herein;

FIG. 11 is a schematic flow chart showing an example method in the first network function, according to the embodiments herein, according to the embodiments herein;

FIG. 12 is a schematic flow chart showing an example method in the second network function, according to the embodiments herein;

FIG. 13 is a schematic flow chart showing an example method in the third network function, according to the embodiments herein;

FIG. 14 is a schematic block diagram showing an example first network function, according to the embodiments herein;

FIG. 15 is a schematic block diagram showing an example second network function, according to the embodiments herein;

FIG. 16 is a schematic block diagram showing an example third network function, according to the embodiments herein;

FIG. 17 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown.

These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

For the purposes of the present disclosure, the terms given in 3GPP TR 21.905 [1] and the following apply. A term defined in the present disclosure takes precedence over the definition of the same term, if any, in 3GPP TR 21.905 [1].

Application Context: A set of data about the Application Client (AC) that resides in the Edge Application Server.

Application Context Relocation: Refers to the end-to-end service continuity procedure described in clause 8.8 of 3GPP TS 23.558.

Application Context Transfer: Refers to the transfer of the Application Context between the source Edge Application Server (S-EAS) and the target Edge Application Server (T-EAS), which is a part of the service continuity procedure described in clause 8.8 of 3GPP TS 23.558.

Application Server: Application software resident in the cloud performing the server function.

Edge Computing: A concept, as described in 3GPP TS 23.501 [2], that enables operator and 3rd party services to be hosted close to the UE's access point of attachment, to achieve an efficient service delivery through the reduced end-to-end latency and load on the transport network.

Edge Computing Service Provider: A mobile network operator or a third party service provider offering Edge Computing service.

Edge Data Network: A local Data Network that supports the architecture for enabling edge applications.

Edge Enabler Client Context: A set of data about the Edge Enabler Client that resides in the Edge Enabler Server.

Edge Hosting Environment: An environment providing support required for Edge Application Server's execution.

Edge-3 exposure context: A set of data about the EDGE-3 exposure subscription that resides in the EES. Such context also includes the 3GPP Core Network context information (created during Edge-3 interaction) if any.

The embodiments herein propose to add an EDGE-3 exposure context transfer between the EESs and harmonizes the post-ACR procedure. The EDGE-3 exposure context may be transferred from the Source EES (S-EES) to the Target EES (T-EES) so that the T-EAS can utilize the existing exposure subscriptions in the T-EES. If the T-EAS receives the corresponding correlation ID from the S-EAS, it can request the T-EES by including the correlation ID and then the T-EES can retrieve the EDGE-3 exposure context from the S-EES; otherwise, the T-EAS can re-subscribe the exposure subscriptions on the T-EES.

The embodiments herein also propose to have a common post-ACR procedure for several scenarios.

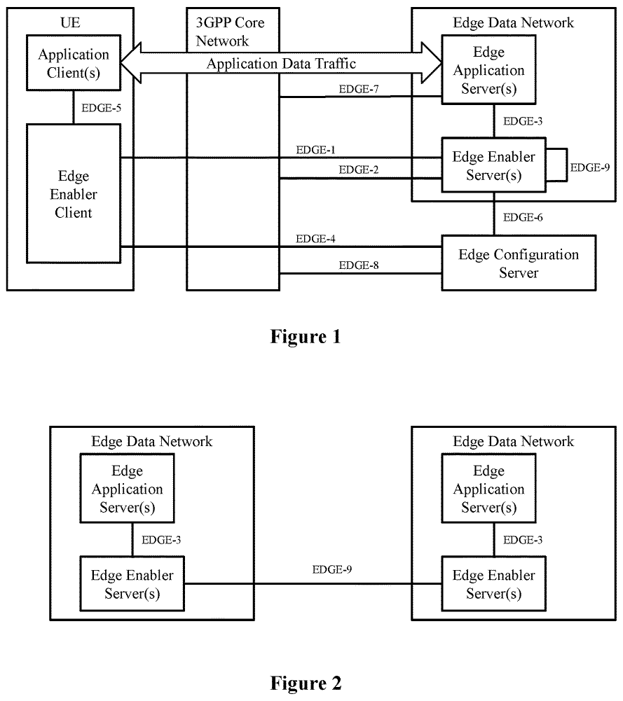

FIG. 1 is a schematic block diagram showing example architecture for enabling Edge applications. As shown in FIG. 1, the EDN is a local Data Network. EAS(s) and the EES are contained within the EDN. The Edge Configuration Server (ECS) provides configurations related to the EES, including details of the EDN hosting the EES. The UE contains AC(s) and the EEC. The EAS(s), the EES and the ECS may interact with the 3GPP Core Network.

As shown in FIG. 1, EDGE-3 reference point enables interactions between the EES and the EASs.

The EDGE-3 reference point may support:
a) registration of EASs with availability information (e.g. time constraints, location constraints);
b) de-registration of EASs from the EES;
c) discovery of target EAS information to support application context transfer;
d) providing access to network capability information (e.g. location information, QoS related information); and
e) requesting the setup of a data session between AC and EAS with a specific QoS.

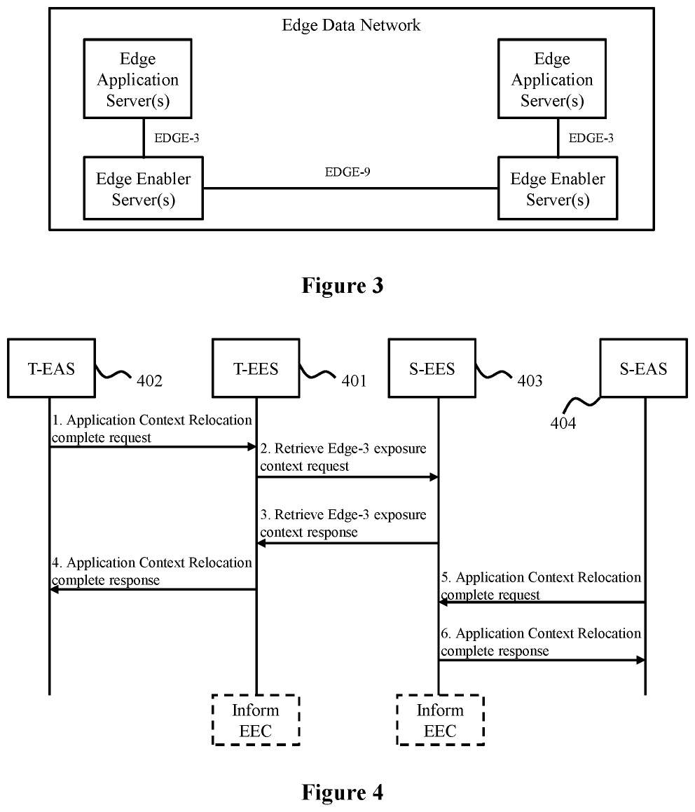

FIG. 2 is a schematic block diagram showing an example inter-EDN EDGE-9. FIG. 3 is a schematic block diagram showing an example intra-EDN EDGE-9. As shown in FIGS. 1-3, EDGE-9 reference point may be provided between two EESs within different EDNs (FIG. 2) or within the same EDN (FIG. 3), and may enable interactions between two EESs.

The EDGE-9 reference point may support:
a) discovery of target EAS information to support application context relocation;
b) EEC context retrieval and relocation procedures; and
c) Edge-3 exposure context retrieval procedure.

For subscribe-notify type of EDGE-3 interaction (e.g. location or QoS subscription), the EES has the exposure context created upon EAS triggered subscription. During ACR, as described in the following embodiments herein, such Edge-3 exposure context can be transferred from the S-EES to the T-EES so that the T-EAS can re-use the existing subscription.

FIG. 4 is a schematic signaling chart showing the messages in the Application Context Relocation complete procedure, according to the embodiments herein.

When a UE moves to, or the UE is expecting to move to, a new location which is outside the service area of the serving EAS (for example S-EAS 404), compared with the serving EAS, a different EAS (for example T-EAS 402) may be more suitable for serving the UE. The transitions from the S-EAS 404 to T-EAS 401 may also require the support from the edge enabler layer to maintain the continuity of the service. For example, in addition to the Application Context Relocation, the EDGE-3 exposure context may be transferred from the serving EES (for example S-EES 403) to a target EES (for example T-EES 401), which is expected to be the new serving EES.

In an embodiment, the EDGE-3 exposure context transfer may be implemented in an ACR complete procedure as shown in FIG. 4.

In an embodiment, the following pre-condition is satisfied before performing the ACR complete procedure.

1. The application context transfer is finished in the EAS.

In an embodiment, the ACR complete procedure may include the following messages or steps:

Step 1. The T-EAS 402 sends ACR complete request message to the T-EES 401.

In an embodiment, the information elements for the ACR complete request from the T-EAS 402 to the T-EES 401 is shown in table 1.

TABLE 1
ACR complete request

| Information element | Status | Description |
|---|---|---|
| UE ID | O | Identifier of the UE |
| Security credentials | M | Security credentials resulting from a successful |
| | | authorization for the edge computing service. |
| Edge-3 exposure context | O | |
| information | | |
| >List of Edge-3 exposure | M | A list of the Edge-3 exposure subscription or |
| subscription/context id(s) | | context identifiers. |
| >Source EES Endpoint | M | Source EES Endpoint information |

As shown in the table 1, the information regarding exposure context information (such as Edge-3 exposure context information) may be sent from the T-EAS 402 to the T-EES 401, so that the T-EES 401 may retrieve the exposure context information from the S-EES 403 accordingly. The information regarding exposure context information may further include a list of Edge-3 exposure context/subscription ID(s), and the endpoint information of the S-EES 403.

Step 2. If the T-EES 401 receives the Edge-3 exposure context information from the T-EAS 402 in the ACR complete request message, the T-EES 401 may send the Retrieve Edge-3 exposure context request message to the S-EES 403, the request includes a list of Edge-3 exposure subscription/context ID(s), such as the ID(s) received at step 1.

In an embodiment, the information elements for the Retrieve Edge-3 exposure context request from the T-EES 401 to the S-EES 403 is shown in table 2.

TABLE 2
Retrieve Edge-3 exposure context request

| Information element | Status | Description |
|---|---|---|
| UE ID | O | Identifier of the UE |
| Security credentials | M | Security credentials resulting from a successful |
| | | authorization for the edge computing service. |
| List of Edge-3 exposure | M | A list of the Edge-3 exposure subscription or |
| subscription/context id(s) | | context identifiers. |

As shown in the table 1, the Retrieve Edge-3 exposure context request message may include a list of Edge-3 exposure context/subscription ID(s), for which the edge exposure context is to be retrieved.

Step 3. If the request is authorized by the S-EES 403, the S-EES 403 may send the Retrieve Edge-3 exposure context response message to the T-EES 401. The exposure context data is included in the response message.

In an embodiment, the information elements for the Retrieve Edge-3 exposure context response from the S-EES 403 to the T-EES 401 is shown in table 3.

As shown in the table 3, in response to the successful response, the Retrieve Edge-3 exposure context response message may include the retrieved exposure context information, such as the context information of Edge-3 exposure subscriptions.

TABLE 3
Retrieve Edge-3 exposure context response

| Information element | Status | Description |
|---|---|---|
| Successful response | O | Indicates that the request was successful |
| >Edge-3 exposure context | M | The context information of Edge-3 exposure |
| information | | subscriptions. |
| Failure response | O | Indicates that the request failed |
| >Cause | O | Indicates the cause of request failure |

Step 4. The T-EES 401 may responds with ACR complete response message to the T-EAS 402. If Edge-3 exposure context data is successfully retrieved from the S-EES 403, the T-EES 401 may store the retrieved exposure context information (i.e., the received exposure context data) and may update the list of Edge-3 exposure subscription/context ID(s).

In an embodiment, the information elements for the ACR complete response from the T-EES 401 to the T-EAS 402 is shown in table 4.

TABLE 4
ACR complete response

| Information element | Status | Description |
|---|---|---|
| Successful response | O | Indicates that the request was successful |
| >Result of edge-3 exposure | O | If the ACR complete request includes Edge-3 exposure |
| context retrieval | | context information, this IE provides the result of the |
| | | context retrieval. |
| >List of updated Edge-3 | O | If the context retrieval result is successful, the EES may |
| exposure | | provide the updated subscription/context identifier(s). |
| subscription/context id(s) | | The absence of an identifier implies no change for the |
| | | subscription/context identifier. |
| Failure response | O | Indicates that the request failed |
| >Cause | O | Indicates the cause of request failure |

As shown in table 4, in response to the successful response, the ACR complete response message may include the result of Edge-3 exposure context retrieval, and/or a list of updated Edge-3 exposure context/subscription ID(s).

Furthermore, if the T-EES 401 previously has received the ACR request message from the EEC (which resides in the UE), the T-EES 401 may also inform the EEC with ACR complete message.

In an embodiment, upon receiving the updated Edge-3 exposure context/subscription ID(s), the T-EAS 402 may reuse the retrieved exposure context information or re-subscribing the exposure subscriptions on the first network function.

Step 5. The S-EAS 404 may sends the ACR complete request message to the S-EES 403 to confirm that the application context relocation has completed.

Step 6. The S-EES 403 may respond with the ACR complete response message to the S-EAS 404. Furthermore, if the S-EES 403 previously has received the Application Context Relocation request message from the EEC, the S-EES 403 may inform EEC with ACR complete message.

Note that, the above steps 5 to 6 and the above steps 1 to 4 may be perform in any manner, for example, performed in any sequence, performed at the same time, or performed separately.

As shown in the above procedure, the embodiments herein may enhance the ACR complete request and response messages with new information elements related to EDGE-3 exposure context. Furthermore, the embodiments herein introduce new messages Retrieval Edge-3 exposure context request and response.

The embodiments herein offer an option to transfer Edge-3 exposure context between the EESs so that the existing subscriptions can be re-used.

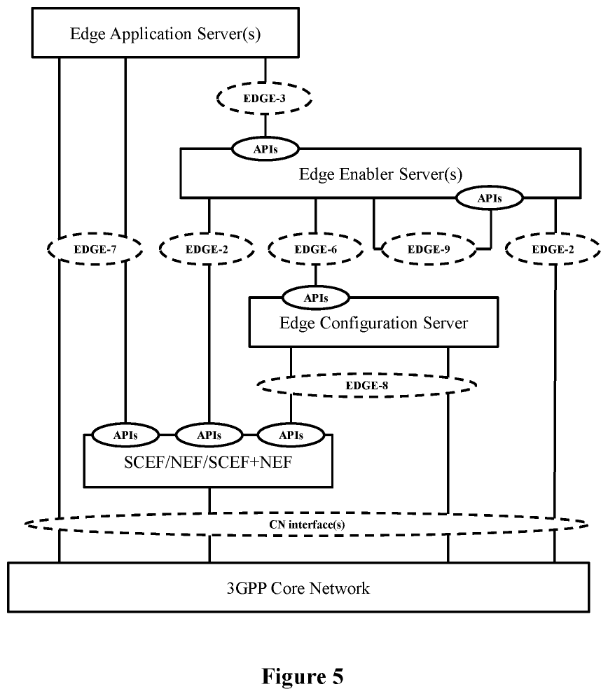

FIG. 5 is a schematic block diagram showing an example capability exposure for enabling edge applications, according to the embodiments herein.

Capability exposure includes the 3GPP core network (i.e. 5G Core Network, Evolved Packet Core), the ECS and the EES capability exposure, to fulfil the needs of the edge service operations. The capability exposure functionality is utilized by the functional entities (i.e. EES, EAS and ECS) depicted in the architecture for enabling the edge applications.

In an embodiment, APIs provided by the ECS are shown in table 5.

TABLE 5
APIs provided by the ECS

| API Name | References |
|---|---|
| Eecs_ServiceProvisioning | clause 8.3 of 3GPP TS 23.558 |
| Eecs_EESRegistration | clause 8.4.4 of 3GPP TS 23.558 |

In an embodiment, APIs provided by the EES are shown in table 6.

TABLE 6
APIs provided by the EES

| API Name | References |
|---|---|
| Eees_EECRegistration | clause 8.4.2 of 3GPP TS 23.558 |
| Eees_EASRegistration | clause 8.4.3 of 3GPP TS 23.558 |
| Eees_EASDiscovery | clause 8.5 of 3GPP TS 23.558 |
| Eees_UELocation | clause 8.6.2 of 3GPP TS 23.558 |
| Eees_UPPathManagementEvent | clause 8.6.3 of 3GPP TS 23.558 |
| Eees_AppClientInformation | clause 8.6.4 of 3GPP TS 23.558 |
| Eees_UEIdentifier | clause 8.6.5 of 3GPP TS 23.558 |
| Eees_SessionWithQoS | clause 8.6.6 of 3GPP TS 23.558 |
| Eees_TargetEASDiscovery | clause 8.8.3.2 of 3GPP TS 23.558 |
| Eees_AppContextRelocation | clause 8.8.3.4 of 3GPP TS 23.558 |
| Eees_ContextRetrieval | proposed embodiments |

In an embodiment, several detailed APIs are shown in the following tables 7-10.

In an embodiment, API for fetching target EAS is shown in table 7.

TABLE 7
Eees_TargetEASDiscovery API

| | API | Operation | |
|---|---|---|---|
| API Name | Operations | Semantics | Consumer(s) |
| Eees_TargetEASDiscovery | Request | Request/Response | EAS |

In an embodiment, API for discovering target EES is shown in table 8.

TABLE 8
Eecs_TargetEESDiscovery API

| | API | Operation | |
|---|---|---|---|
| API Name | Operations | Semantics | Consumer(s) |
| Eecs_TargetEESDiscovery | Request | Request/Response | EES |

In an embodiment, API for application context relocation is shown in table 9.

TABLE 9
Eees_AppContextRelocation API

| API Name | API Operations | Operation Semantics | Consumer(s) |
|---|---|---|---|
| Eees_AppContextRelocation | Request | Request/Response | EEC |

In an embodiment, API for context retrieval is shown in table 10.

TABLE 10
Eees_ContextRetrieval API

| | API | Operation | |
|---|---|---|---|
| API Name | Operations | Semantics | Consumer(s) |
| Eees_ContextRetrieval | Request | Request/Response | EES |

As shown above, the embodiments herein also introduce the corresponding new EES API for the introduced new messages Retrieval Edge-3 exposure context request and response.

Note that, for the Eees_ContextRetrieval API, it is currently used for Edge-3 exposure context retrieval, in the future, such API may be re-used with more context retrieval (e.g. Edge-1 exposure).

In an embodiment, the Eees_ContextRetrieval_Request operation may be defined as follows.

API operation name: Eees_ContextRetrieval_Request.

Description: The consumer requests for the context retrieval.

Inputs: See the above table 2.

Outputs: See the above table 3.

See the description with respect to FIG. 5 for details of usage of this operation.

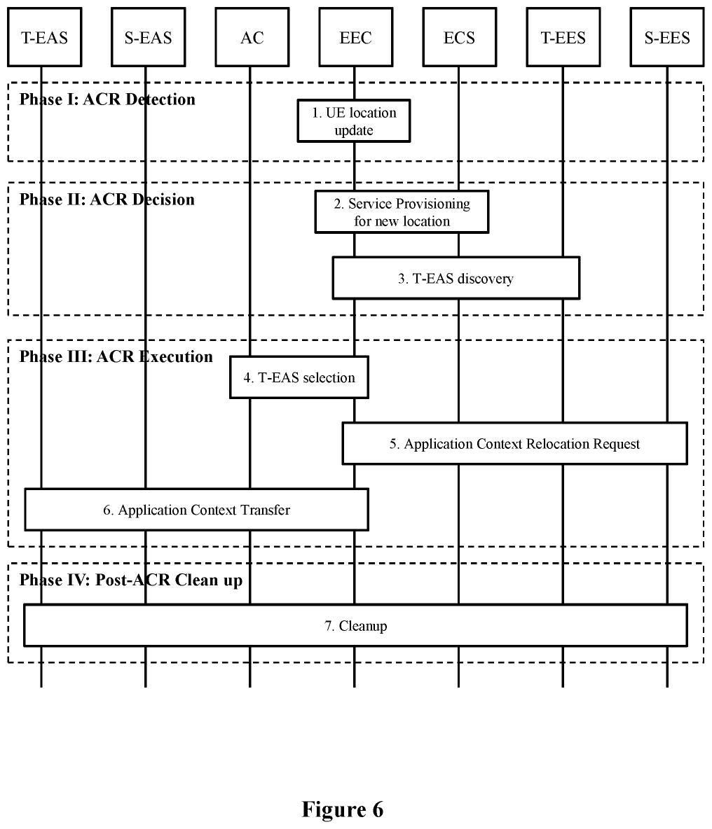

FIG. 6 is a schematic signaling chart showing the messages in the ACR procedure initiated by EEC and ACs, according to the embodiments herein.

This procedure handles ACR as a result of the UE moving to, or the UE expecting to move to, a new location which is outside the service area of the serving EAS. It further relies on the EEC being triggered as a result of the UE's movement.

This procedure is based on Service Provisioning (as specified in clause 8.3 of 3GPP TS 23.558) and EAS Discovery (as specified in clause 8.5 of 3GPP TS 23.558) procedures to discover the target EESs and EASs that shall serve the ACs as a result of the UE's new location, and that shall receive the Application Context from the serving EASs.

The following procedure describes the relocation of a single application context to a new EAS. It should be repeated for each active AC in the UE This procedure relies on an interface between the EEC and ACs over EDGE-5.

In an embodiment, the following pre-conditions are satisfied before performing this procedure.
1. The AC in the UE already has a connection to a corresponding source EAS;
2. The preconditions listed in clause 8.3.3.2.2 of 3GPP TS 23.558 with regards to the EEC are fulfilled; and
3. The EEC is triggered when it obtains the UE's new location, or is triggered by another entity such as an ECS notification.

In an embodiment, the procedure shown in FIG. 6 may include the following phases, each of which may further comprise one or more messages or steps:

Phase I: ACR Detection

Step 1. The EEC is triggered as a result of a UE mobility event, and provided with the UE's new location as described in clause 8.8.1 of 3GPP TS 23.558.

Note that, if the EEC is triggered by an external entity such as by a notification from the ECS, a list of new EESs (to be used as target EESs) is provided by that notification and step 2 below is skipped.

Phase II: ACR Decision

Step 2. The EEC performs Service Provisioning (as specified in clause 8.3 of 3GPP TS 23.558) for all active applications. Since the location of the UE has changed, this procedure results in a list of T-EESs that are relevant to the supplied applications and the new location of the UE. If this procedure is used for service continuity planning, then the Connectivity information and UE Location in the Service Provisioning (as specified in clause 8.3 of 3GPP TS 23.558) procedure contains the expected Connectivity information and expected UE Location.

Note that, if the change in UE's location does not trigger a need to change the serving EAS, the subsequent steps will not take place. The EEC remains connected to the serving EESs and the ACs remain connected to their corresponding serving EASs.

Step 3. Using the provisioned target EESs, the EEC performs EAS discovery (as specified in clause 8.5 of 3GPP TS 23.558) for the desired target EASs by querying the target EESs that were established in step 2 (or provided in the notification from the ECS—if it was the trigger).

Phase III: ACR Execution

Step 4. The AC and EEC select the target EAS to be used for the application traffic, as described in clause 8.5.1 of 3GPP TS 23.558 EAS discovery. Step 4 is skipped if EEC selects only one target EAS.

Step 5. The EEC may send the ACR Request message (without indicating the need to notify the EAS) to the S-EES, the S-EES may apply the AF traffic influence with the N6 routing information of the T-EAS in the 3GPP Core Network (if applicable), as described in clause 8.8.3.4 of 3GPP TS 23.558.

Step 6. The AC is triggered by the EEC to start Application Context Transfer. The AC decides to initiate the transfer of application context from the source EAS to the target EAS. There may be different ways of transferring context. After the ACR is completed, the AC remains connected to the target EAS and disconnects from the source EAS; the EEC is informed of the completion.

Note that, if used for service continuity planning then the next step is performed after the UE moves to the predicted location.

Phase IV: Post-ACR Clean Up

Step 7. All required entities perform clean-up as described in the above ACR complete procedure as described with respect to FIGS. 4 and 5.

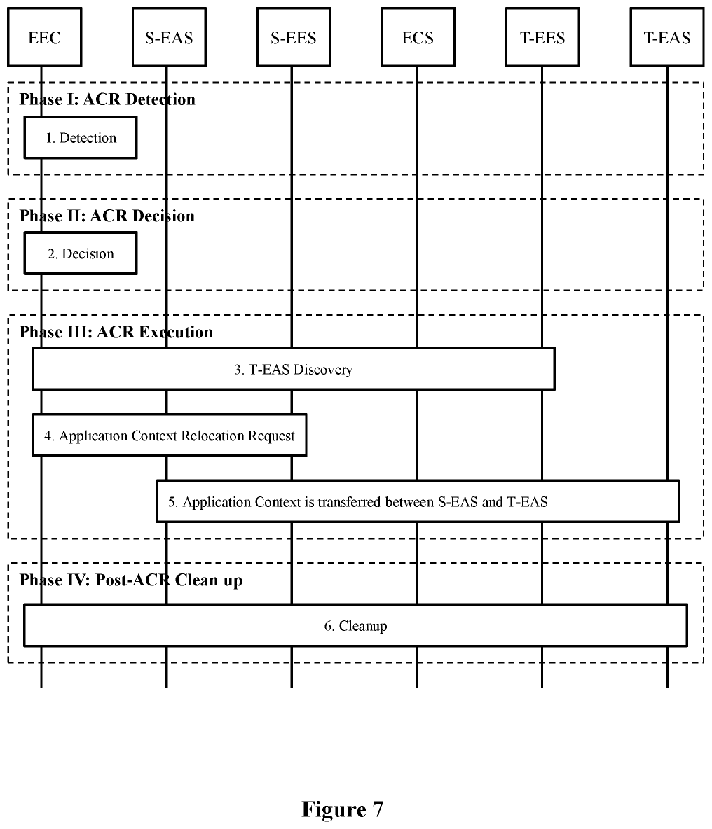

FIG. 7 is a schematic signaling chart showing the messages in the EEC executed ACR procedure, according to the embodiments herein.

In an embodiment, the following pre-conditions are satisfied before performing this ACR procedure.
1. The AC at the UE already has a connection to the S-EAS; and
2. The EEC is able to communicate with the S-EES.

In an embodiment, the procedure shown in FIG. 7 may include the following phases, each of which may further comprise one or more messages or steps:

Phase I: ACR Detection

Step 1. The EEC detects that ACR may be required as described in clause 8.8.1 of 3GPP TS 23.558.

Phase II: ACR Decision

Step 2. The EEC decides to proceed required procedures for triggering ACR.

Phase III: ACR Execution

Step 3. The EEC determines the T-EES by using the provisioned information or performing service provisioning procedure per clause 8.3 of 3GPP TS 23.558. If this procedure is used for service continuity planning, then the Connectivity information and UE Location in the Service Provisioning (as specified in clause 8.3 of 3GPP TS 23.558) procedure contains the expected Connectivity information and expected UE Location. Upon selecting T-EES the UE may need to establish a new PDU connection to the target EDN. The EEC can then discover and select T-EAS by performing EAS Discovery with the T-EES per clause 8.5.2 of 3GPP TS 23.558.

Step 4. The EEC sends the ACR Request message (including the need to notify the EAS) to the S-EES to initiate application context transfer between the S-EAS and the T-EAS. The S-EES authorizes the request from the EEC. The S-EES decides to execute ACR based on the information received by the EEC and the information of EEC context or EAS profile, and may apply the AF traffic influence with the N6 routing information of the T-EAS in the 3GPP Core Network (if applicable) and sends the ACR Notify message to the S-EAS to initiate application context transfer between the S-EAS and the T-EAS, as described in clause 8.8.3.4 of 3GPP TS 23.558.

Step 5. The S-EAS transfers the application context to the T-EAS at implementation specific time.

Note that, if used for service continuity planning then the next step is performed after the UE moves to the predicted location.

Phase IV: Post-ACR Clean up

Step 6. All required entities perform clean-up as described in the above ACR complete procedure as described with respect to FIGS. 4 and 5.

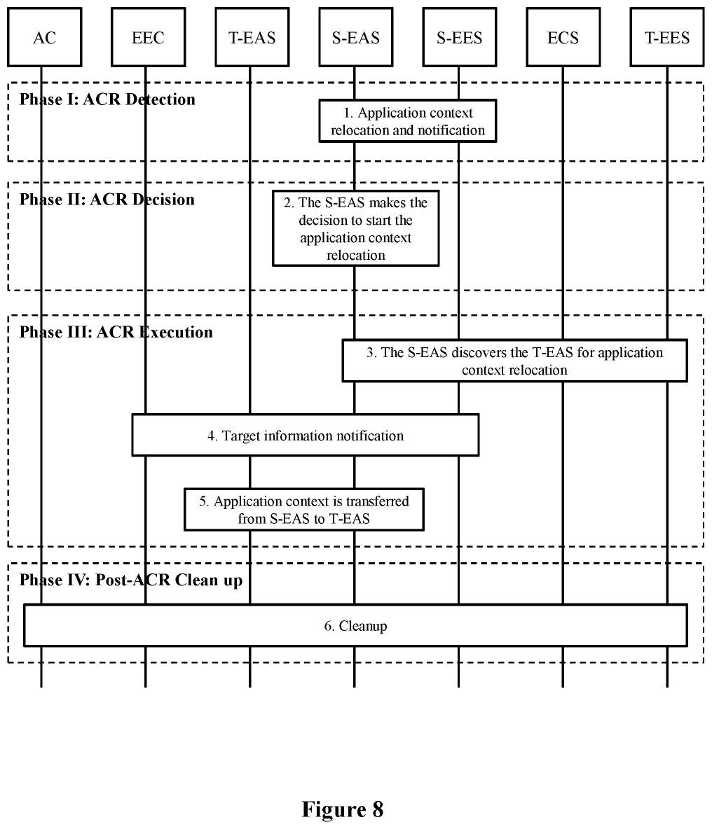

FIG. 8 is a schematic signaling chart showing the messages in the Source EAS decided ACR procedure according to the embodiments herein.

In this procedure, the source EAS may detect the need of ACR locally or is notified by the source EES. The source EAS make the decision about whether to perform the ACR, and starts the ACR at a proper time.

In an embodiment, the following pre-condition is satisfied before performing this ACR procedure.

1. The source EAS may depend on the receipt of certain User plane path management events from the source EES, e.g. “user plane path change” events or “application context relocation monitoring” events, to detect the need for an ACR. For the following procedure it is assumed that the source EAS has subscribed to continuously receive the respective events from the source EES.

The source EAS decided ACR scenario is outlined with four main phases: detection, decision, execution and clean up.

In an embodiment, the procedure shown in FIG. 8 may include the following phases, each of which may further comprise one or more messages or steps:

Phase I: ACR Detection

Step 1. The source EAS either receives notifications from source Edge Enabler Sever indicating that ACR may be required (“application context relocation monitoring” event), or self detects the need for application context relocation (e.g. upon receipt of a “user plane path change” event). If the notification indicates “application context relocation monitoring” event, then the notification will also contain the target EAS information (see clause 8.6.3.2.3 of 3GPP TS 23.558).

Phase II: ACR Decision

Step 2. The source EAS makes the decision to perform the ACR

Phase III: ACR Execution

Step 3. If no target EAS information is available at the source EAS, the source EAS discovers the target EAS as described in clause 8.8.3.2 of 3GPP TS 23.558. After source EAS determines the target EAS to use, the source EAS may apply the AF traffic influence with the N6 routing information of the T-EAS in the 3GPP Core Network (if applicable).

Step 4. The source EES sends the target information notification to the EEC as described in clause 8.8.3.6 of 3GPP TS 23.558.

Step 5. The source EAS transfers the application context to the target EAS selected in step 3.

Phase IV: Post-ACR clean up

Step 6. All required entities perform clean-up as described in the above ACR complete procedure as described with respect to FIGS. 4 and 5.

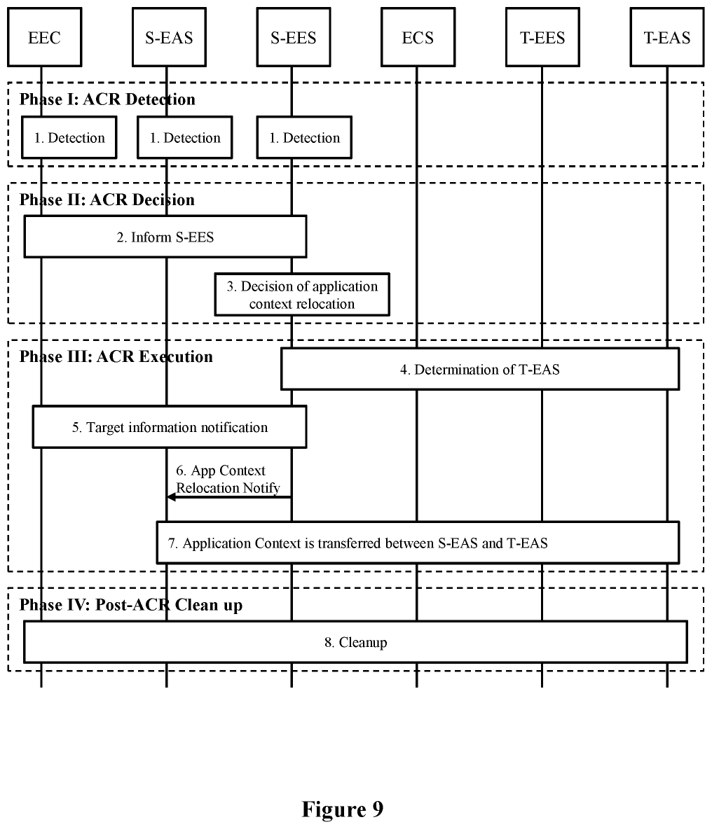

FIG. 9 is a schematic signaling chart showing the messages in the S-EES executed ACR procedure according to the embodiments herein, which illustrates the procedure for the S-EES to decide and execute the ACR from the S-EAS to the T-EAS.

In an embodiment, the following pre-conditions are satisfied before performing this ACR procedure.
1. The AC at the UE already has a connection to the S-EAS; and
2. The EEC is able to communicate with the S-EES.

In an embodiment, the procedure shown in FIG. 9 may include the following phases, each of which may further comprise one or more messages or steps:

Phase I: ACR Detection

Step 1. Detection entities (S-EAS, S-EES, EEC) detects that ACR may be required as described in clause 8.8.1 of 3GPP TS 23.558. The detection by the S-EES may be triggered by the User Plane path change notification received from the 3GPP Core Network.

Step 2. The detection entity informs the S-EES that ACR is required as in clause 8.8.3.5 of 3GPP TS 23.558.

Phase II: ACR Decision

Step 3. The S-EES authorizes the received message from step 2. The S-EES decides to execute ACR based on the information received in step 2 and the information of EEC context or EAS profile, and then proceed the below steps.

Phase III: ACR Execution

Step 4. The S-EES determines T-EES and T-EAS via the Discover target EAS procedure in clause 8.8.3.2 of 3GPP TS 23.558. The S-EES may decide not to perform ACR if T-EAS is not available.

Step 5. The source EES sends the target information notification to the EEC as described in clause 8.8.3.6 of 3GPP TS 23.558.

Step 6. The S-EES may apply the AF traffic influence with the N6 routing information of the T-EAS in the 3GPP Core Network (if applicable) and sends the ACR Notify message to the S-EAS to initiate application context transfer between the S-EAS and the T-EAS.

Step 7. The S-EAS transfers the application context to the T-EAS at implementation specific time.

Phase IV: Post-ACR Clean up

Step 8. All required entities perform clean-up as described in the above ACR complete procedure as described with respect to FIGS. 4 and 5.

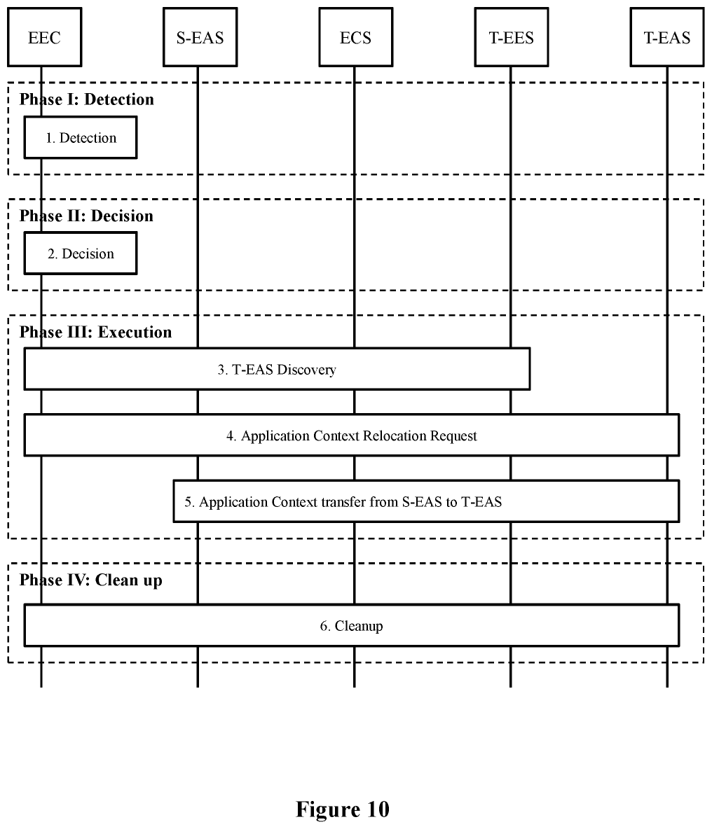

FIG. 10 is a schematic signaling chart showing the messages in the EEC executed ACR via T-EES according to the embodiments herein, which illustrates the procedure for the EEC to execute the ACR via target EES.

In an embodiment, the following pre-condition is satisfied before performing this ACR procedure.

1. The EEC has the source EAS information that serves the AC.

In an embodiment, the procedure shown in FIG. 10 may include the following phases, each of which may further comprise one or more messages or steps:

Phase I: ACR Detection

Step 1. The EEC detects that ACR may be required as described in clause 8.8.1 of 3GPP TS 23.558.

Phase II: ACR Decision

Step 2. The EEC decides to proceed with required procedures for ACR.

Note that, if supported, the AC can be involved in the decision.

Phase III: ACR Execution

Step 3. The EEC determines the T-EES by using the provisioned information or performing service provisioning procedure per clause 8.3 of 3GPP TS 23.558. Upon selecting the T-EES the UE may need to establish a new PDU connection to the target EDN. The EEC performs EAS Discovery with the T-EES per clause 8.5.2 of 3GPP TS 23.558.

Step 4. The EEC sends the ACR Request message (indicating the need to notify the EAS) containing the source EAS and target EAS information to the T-EES. The T-EES may apply the AF traffic influence with the N6 routing information of the T-EAS in the 3GPP Core Network (if applicable). Then the T-EES sends the ACR Notify message to the T-EAS, as described in clause 8.8.3.4 of 3GPP TS 23.558.

Step 5. The T-EAS initiates application context transfer between the S-EAS and the T-EAS.

Phase IV: Post-ACR clean up

Step 6. All required entities perform clean-up as described in the above ACR complete procedure as described with respect to FIGS. 4 and 5.

If the procedure fails after step 4, it will be terminated with an appropriate cause in the ACR Response message to the EEC in step 6. The EEC may then proceed attempting to obtain services from the T-EAS discovered in step 3 without service continuity support. Alternatively, the EEC may resume the present procedure starting with step 3 and selecting a different T-EES.

Note that, the support of ACR between EDNs operated by different ECSPs is dependent on business agreement between the ECSPs.

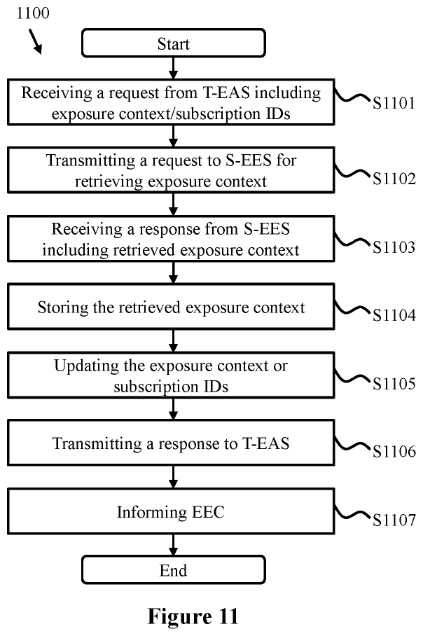

FIG. 11 is a schematic flow chart showing an example method 1100 in the first network function, according to the embodiments herein. In an embodiment, the flow chart in FIG. 11 may be implemented in the first network function (such as the T-EES 401) in FIGS. 3-10.

The method 1100 may begin with step S1101, in which the first network function may receive, from a second network function implementing EAS (such as the T-EAS 402), a first request message comprising information regarding exposure context information.

In an embodiment, the first request message may be ACR complete request message. Furthermore, the information regarding exposure context information may include a list of Edge-3 exposure context or subscription IDs, and the endpoint information of a third network function (such as the S-EES 403).

In an embodiment, the second network function may be associated with the first network function, for example, the second network function may be registered on the first network function.

In an embodiment, the exposure context information may be EDGE-3 exposure context information.

In an embodiment, the context information of Edge-3 exposure subscriptions may be used for providing access to network capability information, such as location information, QoS related information, and User Plane Path Management related information.

In an embodiment, the context information of Edge-3 exposure subscriptions may include the 3GPP Core Network context information created during Edge-3 interaction.

Then, the method 1100 may proceed to step S1102, in which the first network function may transmit, to the third network function, a second request message for retrieving the exposure context information, in response to the information regarding exposure context information.

In an embodiment, the second request message may be Retrieve Edge-3 exposure context request message, and may include the list of Edge-3 exposure context or subscription IDs.

In an embodiment, the third network function may be the serving network function for a UE. Furthermore, the first network function and the second network function will be the serving network functions for the UE.

In an embodiment, the third network function may be located in a first EDN, while the first network function and the second network function may be located in a second different EDN. In another embodiment, the first network function, the second network function, and the third network function may be located in the same EDN.

Then, the method 1100 may proceed to step S1103, in which the first network function may receive, from the third network function, a first response message including the retrieved exposure context information.

In an embodiment, the first response message may be Retrieve Edge-3 exposure context response message. In an embodiment, the retrieved exposure context information may include the context information of Edge-3 exposure subscriptions.

Then, the method 1100 may proceed to step S1104, in which the first network function may store the retrieved exposure context information.

Then, the method 1100 may proceed to step S1105, in which the first network function may update the list of Edge-3 exposure context or subscription IDs, in response to the retrieved exposure context information.

Then, the method 1100 may proceed to step S1106, in which the first network function may transmit, to the second network function, a second response message including information regarding the retrieved exposure context information.

In an embodiment, the second response message may be ACR complete response message, and may include the result of Edge-3 exposure context retrieval, and/or a list of updated Edge-3 exposure context or subscription IDs.

In an embodiment, the first request message and the second response message may be sent over the Edge-3 reference point. Furthermore, the second request message and the first response message may be sent over the Edge-9 reference point.

In an embodiment, the second request message and the first response message may be sent and received via the Eees_ContextRetrieval API provided by the first network function and the third network function.

Then, the method 1100 may proceed to step S1107, in which the first network function may transmit, to a component (such as EEC) in the UE, an ACR complete message.

Note that, the above steps S1104 and Step S1105-S1106 may be perform in any manner, for example, performed in any sequence, performed at the same time, or performed separately.

The above steps are only examples, and the first network function may perform any actions described with respect to FIGS. 3-10, to transfer the edge exposure context, by for example Application Context Relocation complete procedure.

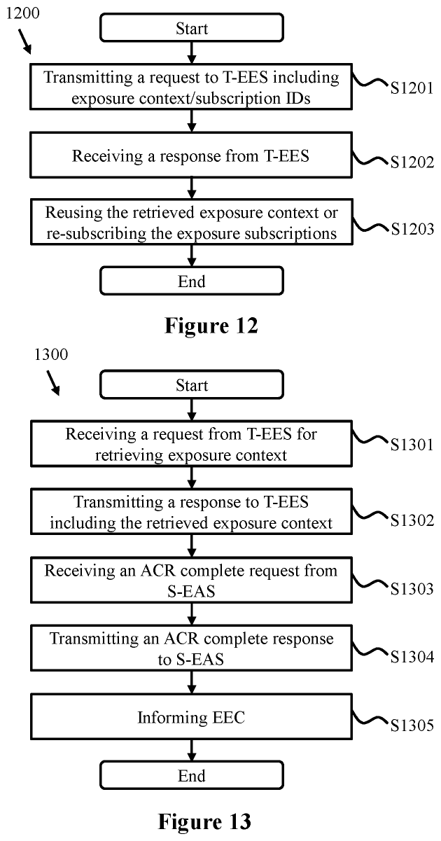

FIG. 12 is a schematic flow chart showing an example method 1200 in the second network function, according to the embodiments herein. In an embodiment, the flow chart in FIG. 12 may be implemented in the second network function (such as the T-EAS 402) in FIGS. 3-10.

The method 1200 may begin with step S1201, in which the second network function may transmit, to a first network function implementing EES (such as the T-EES 401), a request message comprising information regarding exposure context information.

In an embodiment, the request message may be ACR complete request message. Furthermore, the information regarding exposure context information may include a list of Edge-3 exposure context or subscription IDs, and the endpoint information of a third network function (such as the S-EES 403).

In an embodiment, the second network function may be associated with the first network function, for example, the second network function may be registered on the first network function.

In an embodiment, the exposure context information may be EDGE-3 exposure context information.

In an embodiment, the context information of Edge-3 exposure subscriptions may be used for providing access to network capability information, such as location information, QoS related information, and User Plane Path Management related information.

In an embodiment, the context information of Edge-3 exposure subscriptions may include the 3GPP Core Network context information created during Edge-3 interaction.

Then, the method 1200 may proceed to step S1202, in which the second network function may receive, from the first network function, a response message including information regarding the retrieved exposure context information, which is retrieved from a third network function implementing EES (such as the S-EES 403).

In an embodiment, the response message may be ACR complete response message, and may include the result of Edge-3 exposure context retrieval, and/or a list of updated Edge-3 exposure context or subscription IDs.

In an embodiment, the third network function may be the serving network function for a UE. Furthermore, the first network function and the second network function will be the serving network functions for the UE.

In an embodiment, the third network function may be located in a first EDN, while the first network function and the second network function may be located in a second different EDN. In another embodiment, the first network function, the second network function, and the third network function may be located in the same EDN.

In an embodiment, the request message and the response message may be sent over the Edge-3 reference point. Furthermore, the exposure context information may be retrieved over the Edge-9 reference point.

In an embodiment, the exposure context information may be retrieved via the Eees_ContextRetrieval API provided by the first network function and the third network function.

Then, the method 1200 may proceed to step S1203, in which the second network function may reuse the retrieved exposure context information, or re-subscribe the exposure subscriptions on the first network function.

The above steps are only examples, and the second network function may perform any actions described with respect to FIGS. 3-10, to transfer the edge exposure context, by for example Application Context Relocation complete procedure.

FIG. 13 is a schematic flow chart showing an example method 1300 in the third network function, according to the embodiments herein. In an embodiment, the flow chart in FIG. 13 may be implemented in the third network function (such as the S-EES 403) in FIGS. 3-10.

The method 1300 may begin with step S1301, in which the third network function may receive, from the first network function implementing EES (such as the T-EES 401), a request message for retrieving exposure context information.

In an embodiment, the second request message may be Retrieve Edge-3 exposure context request message, and may include the list of Edge-3 exposure context or subscription IDs.

In an embodiment, the exposure context information may be EDGE-3 exposure context information.

In an embodiment, the context information of Edge-3 exposure subscriptions may be used for providing access to network capability information, such as location information, QoS related information, and User Plane Path Management related information.

In an embodiment, the context information of Edge-3 exposure subscriptions may include the 3GPP Core Network context information created during Edge-3 interaction.

In an embodiment, the third network function may be the serving network function for a UE. Furthermore, the first network function will be the serving network functions for the UE.

In an embodiment, the third network function may be located in a first EDN, while the first network function may be located in a second different EDN. In another embodiment, the first network function and the third network function may be located in the same EDN.

Then, the method 1300 may proceed to step S1302, in which the third network function may transmit, to the first network function, a response message including the retrieved exposure context information.

In an embodiment, the response message may be Retrieve Edge-3 exposure context response message. In an embodiment, the retrieved exposure context information may include the context information of Edge-3 exposure subscriptions.

In an embodiment, the request message and the response message may be sent over the Edge-9 reference point.

In an embodiment, the request message and the response message may be sent and received via the Eees_ContextRetrieval API provided by the first network function and the third network function.

Then, the method 1300 may proceed to step S1303, in which the third network function may receive an ACR complete request message from a fourth network function implementing EAS (such as the S-EAS 404). Note that, this ACR complete request message may be a legacy message.

Then, the method 1300 may proceed to step S1304, in which the third network function may transmit an ACR complete response message to the fourth network function. Note that, this ACR complete response message may be a legacy message.

In an embodiment, the fourth network function may be associated with the third network function, for example, the fourth network function may be registered on the third network function.

Then, the method 1300 may proceed to step S1305, in which the third network function may transmit, to a component (such as EEC) in the UE, an ACR complete message.

Note that, the above steps S1301-S1302 and Step S1303-S1305 may be perform in any manner, for example, performed in any sequence, performed at the same time, or performed separately.

The above steps are only examples, and the third network function may perform any actions described with respect to FIGS. 3-10, to transfer the edge exposure context, by for example Application Context Relocation complete procedure.

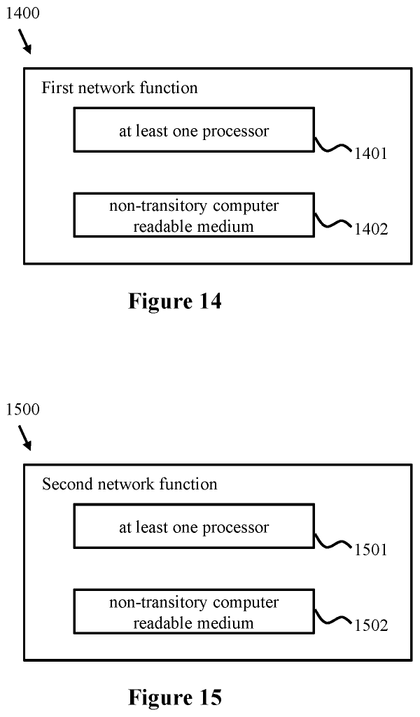

FIG. 14 is a schematic block diagram showing an example first network function (such as the T-EES 401), according to the embodiments herein.

In an embodiment, the first network function 1400 may include at least one processor 1401; and a non-transitory computer readable medium 1402 coupled to the at least one processor 1401. The non-transitory computer readable medium 1402 contains instructions executable by the at least one processor 1401, whereby the at least one processor 1401 is configured to perform the steps in the example method 1100 as shown in the schematic flow chart of FIG. 11; the details thereof are omitted here.

Note that, the first network function 1400 may be implemented as hardware, software, firmware and any combination thereof. For example, the first network function 1400 may include a plurality of units, circuities, modules or the like, each of which may be used to perform one or more steps of the example method 1100 or one or more steps shown in FIGS. 3-10 related to the first network function (such as the T-EES 401).

It should be understood that, the first network function may be implemented either as a network element on a dedicated hardware, as a software instance running on a dedicated hardware, or as a virtualized function instantiated on an appropriate platform, e.g. on a cloud infrastructure.

FIG. 15 is a schematic block diagram showing an example second network function (such as the T-EAS 402), according to the embodiments herein.

In an embodiment, the second network function 1500 may include at least one processor 1501; and a non-transitory computer readable medium 1502 coupled to the at least one processor 1501. The non-transitory computer readable medium 1502 contains instructions executable by the at least one processor 1501, whereby the at least one processor 1501 is configured to perform the steps in the example method 1200 as shown in the schematic flow chart of FIG. 12; the details thereof are omitted here.

Note that, the second network function 1500 may be implemented as hardware, software, firmware and any combination thereof. For example, the second network function 1500 may include a plurality of units, circuities, modules or the like, each of which may be used to perform one or more steps of the example method 1200 or one or more steps shown in FIGS. 3-10 related to the second network function (such as the T-EAS 402).

It should be understood that, the second network function may be implemented either as a network element on a dedicated hardware, as a software instance running on a dedicated hardware, or as a virtualized function instantiated on an appropriate platform, e.g. on a cloud infrastructure.

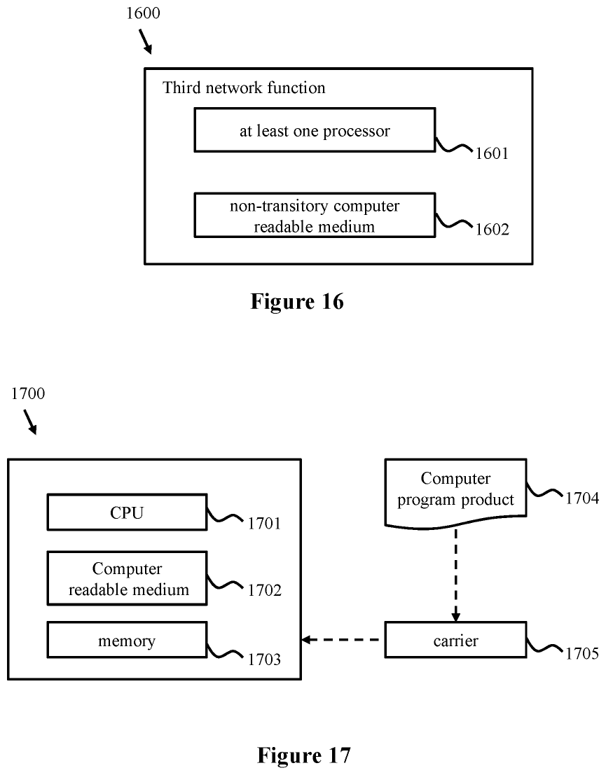

FIG. 16 is a schematic block diagram showing an example third network function (such as the S-EES 403), according to the embodiments herein.

In an embodiment, the third network function 1600 may include at least one processor 1601; and a non-transitory computer readable medium 1602 coupled to the at least one processor 1601. The non-transitory computer readable medium 1602 contains instructions executable by the at least one processor 1601, whereby the at least one processor 1601 is configured to perform the steps in the example method 1300 as shown in the schematic flow chart of FIG. 11; the details thereof are omitted here.

Note that, the third network function 1600 may be implemented as hardware, software, firmware and any combination thereof. For example, the third network function 1600 may include a plurality of units, circuities, modules or the like, each of which may be used to perform one or more steps of the example method 1300 or one or more steps shown in FIGS. 3-10 related to the third network function (such as the S-EES 403).

It should be understood that, the third network function may be implemented either as a network element on a dedicated hardware, as a software instance running on a dedicated hardware, or as a virtualized function instantiated on an appropriate platform, e.g. on a cloud infrastructure.

FIG. 17 is a schematic block diagram showing an example computer-implemented apparatus 1700, according to the embodiments herein.

In an embodiment, the apparatus 1700 may be configured as the above mentioned apparatus, such as the first network function (such as the T-EES 401), the second network function (such as the T-EAS 402), or the third network function (such as the S-EES 403).

In an embodiment, the apparatus 1700 may include but not limited to at least one processor such as Central Processing Unit (CPU) 1701, a computer-readable medium 1702, and a memory 1703. The memory 1703 may comprise a volatile (e.g. Random Access Memory, RAM) and/or non-volatile memory (e.g. a hard disk or flash memory). In an embodiment, the computer-readable medium 1702 may be configured to store a computer program and/or instructions, which, when executed by the processor 1701, causes the processor 1701 to carry out any of the above mentioned methods.

In an embodiment, the computer-readable medium 1702 (such as non-transitory computer readable medium) may be stored in the memory 1703. In another embodiment, the computer program may be stored in a remote location for example computer program product 1704 (also may be embodied as computer-readable medium), and accessible by the processor 1701 via for example carrier 1705.

The computer-readable medium 1702 and/or the computer program product 1704 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### Abbreviations

3GPP third Generation Partnership Project
AC Application Client
ACR Application Context Relocation
API Application Programming Interface
EAS Edge Application Server
ECS Edge Configuration Server
EDN Edge Data Network
EEC Edge Enabler Client
EES Edge Enabler Server
ID Identifier
QoS Quality of Service
S-EAS Source EAS
S-EES Source EES
T-EAS Target EAS
T-EES Target EES
TS Technical Specification
UE User Equipment.

1-16. (canceled)

17. A method performed by a second network function implementing Edge Application Server (EAS), comprising:
transmitting, to a first network function implementing Edge Enabler Server (EES), a request message comprising information regarding exposure context information; and
receiving, from the first network function, a response message including information regarding the exposure context information.

18. The method according to claim 17, wherein the exposure context information is EDGE-3 exposure context information.

19. The method according to claim 18,
wherein the information regarding exposure context information includes a list of EDGE-3 subscription identifiers (IDs), and endpoint information of a third network function.

20. The method according to claim 18,
wherein the response message includes a result of EDGE-3 exposure context retrieval, a list of updated EDGE-3 subscription IDs, or both the result of EDGE-3 exposure context retrieval and the list of updated EDGE-3 subscription IDs.

21-24. (canceled)

25. The method according to claim 17, wherein the request message and the response message are sent over an EDGE-3 reference point.

26-46. (canceled)

47. A second network function implementing Edge Application Server (EAS), comprising:
at least one processor; and
a non-transitory computer readable medium coupled to the at least one processor, the non-transitory computer readable medium contains instructions executable by the at least one processor, wherein the at least one processor is configured to perform operations to:
transmit, to a first network function implementing Edge Enabler Server (EES), a request message comprising information regarding exposure context information; and
receive, from the first network function, a response message including information regarding the exposure context information.

48-50. (canceled)

51. The method according to claim 17, wherein the exposure context information is retrieved from a third network function implementing EES.
